(19) United States
(12) Patent Application Publication
(10) Pub. No.: US 2023/0120896 A1
(43) Pub. Date: Apr. 20, 2023

(54) SYSTEMS AND METHODS FOR DETECTING MODELING ERRORS AT A COMPOSITE MODELING LEVEL IN COMPLEX COMPUTER SYSTEMS

(71) Applicant: Capital One Services, LLC, McLean, VA (US)

(72) Inventor: Aniket BHATTACHARYYA, McLean, VA (US)

(73) Assignee: Capital One Services, LLC, McLean, VA (US)

(21) Appl. No.: 17/559,586

(22) Filed: Dec. 22, 2021

(30) Foreign Application Priority Data
Oct. 20, 2021 (IN) 202141047559

(51) Int. Cl. G06F 16/23

(52) U.S. Cl. CPC G06F 16/2365

(57) ABSTRACT

Described are methods and systems for a model performance and monitoring tool. In particular, methods and systems are described for detecting modeling errors at a composite modeling level in complex computer systems based on modeling errors in non-homogenous, time-series data segments.

### CROSS-REFERENCE TO RELATED APPLICATION

This application claims the benefit of priority of Indian Provisional Application No. 202141047559, filed Oct. 20, 2021. The content of the foregoing application is incorporated herein in its entirety by reference.

### BACKGROUND

In recent years, the use of data modeling and the diversity in data modeling techniques has grown exponentially. Additionally, the types of data and the applications that are modelled have also grown.

### SUMMARY

In view of the increase in the use of data models, methods and systems are described for improvements in data modeling. Specifically, methods and systems are described for a model performance and monitoring tool. For example, in conventional modeling systems, models may be developed for a given data stream segment. This data stream segment may correspond to a particular type of data or a particular application. When modeling this data to generate a forecast or prediction, the predicted amount may be compared to an actual amount in order to evaluate the performance of the model. However, in some applications, such as those relating to more complex systems, modeling becomes more difficult. For example, in more complex systems, the model may be based on multiple factors, data types, and/or data segments. Moreover, in some instances, the model itself may be based on a composite model that depends on inputs from a plurality of other data models. The outputs of these data models may themselves have performance errors, which may affect the overall performance of the composite model.

In such cases, evaluating the performance of a composite model presents several unique technical challenges. First, modeling errors and performance may need to be determined in the aggregate (e.g., based on the predictions of the composite model). However, the errors and issues causing the negative performance may be caused by either the performance issues of the composite model or performance issues of one or more component data models. Accordingly, responding to the errors and issues causing the negative performance may involve adjusting the composite model (e.g., adjusting weights, parameters, and/or hyperparameters of the composite model) and/or adjusting one or more of the underlying component models (e.g., adjusting weights, parameters, and/or hyperparameters of the one or more component models).

Incremental modifications to address errors represent a technical challenge both in detection and response as the effect on a composite model of any component model is a factor of both materiality and bias. For example, conventional methods of addressing such issues require individual tests and evaluation on each component model and/or the composite model. In such cases, a user may generate an individual error summary of a component model to review errors and issues causing the negative performance. However, each component model may have its own materiality (e.g., how much weight is attributed to the composite model) on performance of the composite model and its own bias (e.g., the amount of error that the component model suffers from). As each composite model may receive data from thousands of component models, a user evaluating thousands of reports based upon an understanding of composite level thresholds is prone to overlook a key segment (e.g., having high materiality) under performance, when smaller segments with lower materiality show significantly higher error variance (e.g., bias).

These problems are even further exacerbated when reviewing time-series data as the time-series data introduces yet another relationship that must be monitored and accounted for when looking for correlations in component models that may affect a composite model. In such cases, any monitoring tool must use techniques that maintain the temporal relationships of the data and function in view of the correlations between parallel component models.

In view of the aforementioned technical challenge, methods and systems are described for a model performance and monitoring tool that may detect errors and issues causing the negative performance at both a composite and component level. For example, the methods and systems provide a mechanism for detecting errors and issues causing the negative performance in a composite model and allowing for simultaneous review of the plurality of component models. In order to provide the simultaneous review of the plurality of component models, however, the methods and systems must overcome yet another technical problem. Specifically, as each component model may rely on non-homogenous (e.g., having multiple different factors, data types, and/or data segments) and time-series data segments, conventional monitoring mechanisms would require normalization of each model.

The methods and systems described herein however allow for the comparison and review without individual normalization. As such, the methods and systems may provide a status summary for each of the plurality of time-series data component models simultaneously. The methods and systems achieve this by first detecting a shift in an error mean of the composite data model based on a change point analysis on error distributions in the composite error pattern. Then, in response to detecting the shift in the error mean of the composite data model, the methods and systems, for each of the plurality of the time-series component models, detect component models from which the error is derived, using the non-parametric bias tests and various WMPEs (Weighted Mean Percentage Errors). The use of the non-parametric bias test alleviates the need for normalization, while still allowing the methods and systems to determine a respective proportion of error detections for each of the plurality of time-series data component models. Through this unconventional arrangement and architecture, the limitations of the conventional systems are overcome.

In some aspects, methods and systems are disclosed for detecting modeling errors at a composite modeling level in complex computer systems based on modeling errors in non-homogenous, time-series data segments. For example, the system may receive a plurality of time-series data component models for a first time period, wherein each of the plurality of time-series data component models provide a respective error pattern for a respective forecasting model of a respective data stream segment. The system may aggregate the plurality of time-series data component models into a composite data model for the first time period, wherein the composite data model provides a composite error pattern during the first time period. The system may detect a shift in an error mean of the composite data model based on a change point analysis on error distributions in the composite error pattern. The system may, in response to detecting the shift in the error mean of the composite data model, determine a respective error for each of the plurality of time-series data component models based on a non-parametric bias test; and determine a respective proportion of error detections for each of the plurality of time-series data component models that occurred during the first time period. The system may generate for display, on a user interface, a respective status summary for each of the plurality of time-series data component models, wherein the respective status summary includes the respective error and the respective proportion of error detections for each of the plurality of time-series data component models.

Various other aspects, features, and advantages of the invention will be apparent through the detailed description of the invention and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system diagram for detecting modeling errors at a composite modeling level in complex computer systems, in accordance with one or more embodiments.

FIG. 2A shows an illustrative model scorecard as presented in a user interface, in accordance with one or more embodiments.

FIG. 2B shows an illustrative snapshot diagram as presented in a user interface, in accordance with one or more embodiments.

FIG. 3 shows illustrative components for detecting modeling errors at a composite modeling level in complex computer systems, in accordance with one or more embodiments.

FIG. 4 shows a flowchart of the steps involved in detecting modeling errors at a composite modeling level in complex computer systems, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art, that the embodiments of the invention may be practiced without these specific details or with an equivalent arrangement. In other cases, well-known structures and devices are shown in block diagram form in order to avoid unnecessarily obscuring the embodiments of the invention.

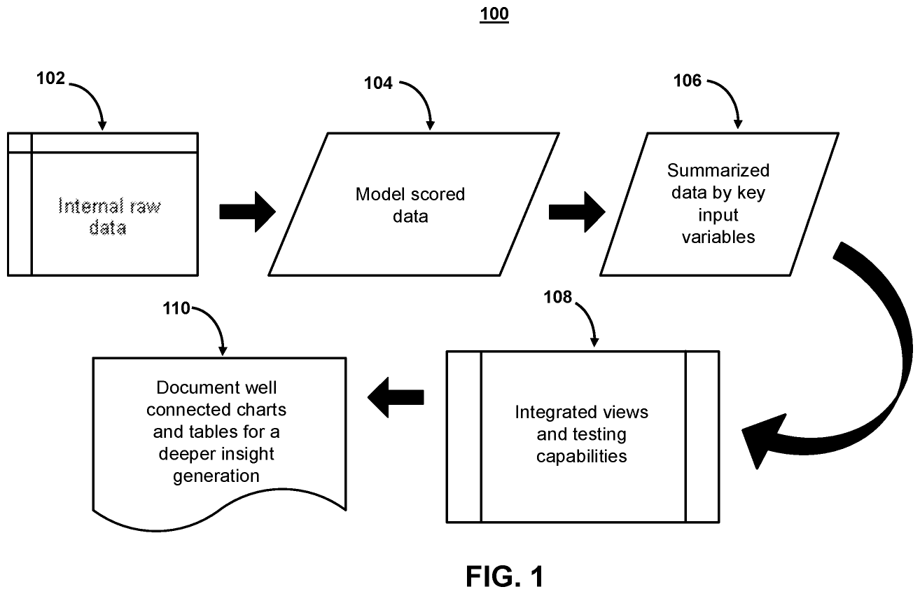

FIG. 1 shows an illustrative system diagram for detecting modeling errors at a composite modeling level in complex computer systems, in accordance with one or more embodiments. For example, for the purpose of evaluating model performance a model developer or validator may need to create multiple charts and tables. At a high level these charts and tables show overall model performance through time while for each snapshot it summarizes performance over a given time period. The model developer may also receive charts and tables for lower levels (e.g., sub-segments of the model). These lower levels may correspond to outputs of models corresponding to the individual sub-segments. In some embodiments, it should be noted that the sub-segment may comprise a data stream segment that is not processed by a corresponding model. For example, the data stream segment may comprise natively received data.

A model corresponding to a next level (e.g., a sub-segment) may represent individual snapshot performances over the same or different time period as the higher level snapshot. Each of these lower levels (e.g., sub-segments) may represents a breakdown by key portfolios, hazards, account statuses, vintages, and/or other categories. The conventional model developer or validator would then be required to evaluate thousands of charts, which have different error patterns through time as well as different error variance where it is difficult to ascertain risk without evaluating the materiality of the segment one is studying. For example, a model for a sub-segment that has low performance, but also low materiality may not affect a higher level model.

As the conventional process is aligned with business defined thresholds at the higher level, it helps the model developer or validator evaluate risk at a higher level (as the business defined thresholds may be key to metrics produced by the higher level model), but as the evaluation is strictly dependent on breaching the threshold at the higher level (e.g., a composite model), certain error trends through time for material sub-segments (e.g., a component model) may be missed in this process.

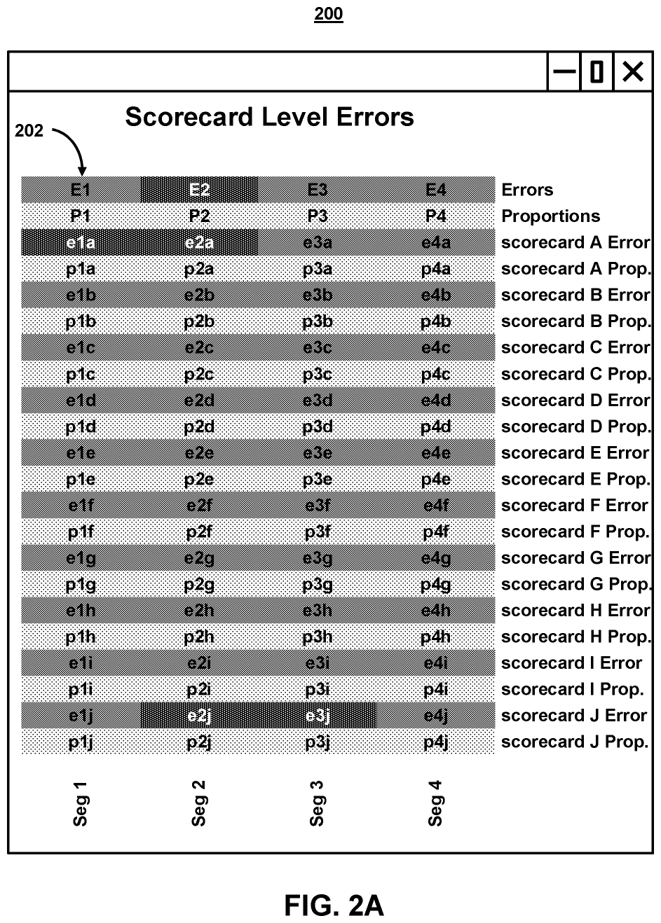

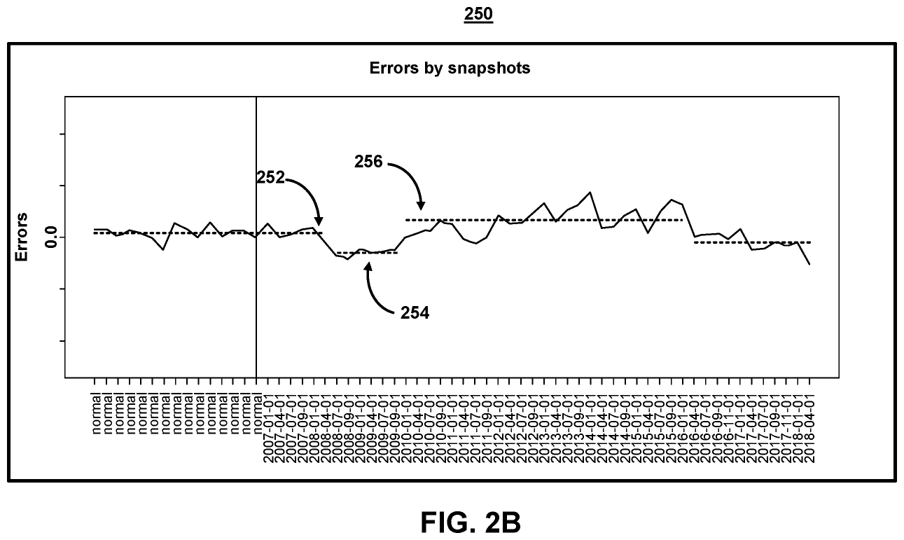

For example, FIG. 1 illustrates the process by which raw data is inputted, processed, and used to provide integrated views (e.g., as described in FIGS. 2A and B) and testing capabilities. For example, as shown in FIG. 1, raw data may be inputted at point 102. The raw internal data may comprise various types of data and models for various applications. For example, the data may include information for governance of retail loss forecasting suite of models (e.g., in which each component model corresponds to a different sub-segment of retail loss such as theft, product returns, etc.), which are used to predict losses for allowance calculation, financial reporting and stress testing. Furthermore, this time-series data and these models may be built on data covering more than ten years of account originations and performance.

As described herein, “time-series data” may include a sequence of data points that occur in successive order over some period of time. In some embodiments, time-series data may be contrasted with cross-sectional data, which captures a point-in-time. A time series can be taken on any variable that changes over time. The system may use a time series to track the variable (e.g., price) of an asset (e.g., security) over time. This can be tracked over the short term, such as the price of a security on the hour over the course of a business day, or the long term, such as the price of a security at close on the last day of every month over the course of five years. The system may generate a time series analysis. For example, a time series analysis may be useful to see how a given asset, security, or economic variable changes over time. It can also be used to examine how the changes associated with the chosen data point compare to shifts in other variables over the same time period. For example, with regards to retail loss, the system may receive time series data for the various sub-segments indicating daily values for theft, product returns, etc.

The time-series analysis may determine various trends such as a secular trend, which describe the movement along the term, a seasonal variations, which represent seasonal changes, cyclical fluctuations, which correspond to periodical but not seasonal variations, and irregular variations, which are other nonrandom sources of variations of series. The system may maintain correlations for this data during modeling. In particular, the system may maintain correlations through non-normalization as normalizing data inherently changes the underlying data which may render correlations, if any, undetectable and/or lead to the detect of false positive correlations. For example, modeling techniques (and the predictions generated by them), such as rarefying (e.g., resampling as if each sample has the same total counts), total sum scaling (e.g., dividing counts by the sequencing depth), and others, and the performance of some strongly parametric approaches, depends heavily on the normalization choices. Thus, normalization may lead to lower model performance and more model errors. The use of anon-parametric bias test alleviates the need for normalization, while still allowing the methods and systems to determine a respective proportion of error detections for each of the plurality of time-series data component models. Through this unconventional arrangement and architecture, the limitations of the conventional systems are overcome. For example, non-parametric bias test are robust to irregular distributions, while providing an allowance for covariate adjustment. Since no distributional assumptions are made, these tests may be applied to data that has been processed under any normalization strategy or not processed under a normalization process at all.

As referred to herein, “a data steam” may refer to data that is received from a data source that is indexed or archived by time. This may include streaming data (e.g., as found in streaming media files) or may refer to data that is received from one or more sources over time (e.g., either continuously or in a sporadic nature). A data stream segment may refer to a state or instance of the data stream. For example, a state or instance may refer to a current set of data corresponding to a given time increment or index value. For example, the system may receive time series data as a data stream. A given increment (or instance) of the time series data may correspond to a data stream segment.

For example, in some embodiments, the analysis of time-series data presents comparison challenges that are exacerbated by normalization. For example, a comparison of original data from the same period in each year does not completely remove all seasonal effects. Certain holidays such as Easter and Chinese New Year fall in different periods in each year, hence they will distort observations. Also, year-to-year values will be biased by any changes in seasonal patterns that occur over time. For example, consider a comparison between two consecutive March months (i.e., compare the level of the original series observed in March for 2000 and 2001). This comparison ignores the moving holiday effect of Easter. Easter occurs in April for most years but if Easter falls in March, the level of activity can vary greatly for that month for some series. This distorts the original estimates. A comparison of these two months will not reflect the underlying pattern of the data. The comparison also ignores trading day effects. If the two consecutive months of March have different composition of trading days, it might reflect different levels of activity in original terms even though the underlying level of activity is unchanged. In a similar way, any changes to seasonal patterns might also be ignored. The original estimates also contain the influence of the irregular component. If the magnitude of the irregular component of a series is strong compared with the magnitude of the trend component, the underlying direction of the series can be distorted. While data may in some cases be normalized to account for this issue, the normalization of one data stream segment (e.g., for one component model) may affect another data stream segment (e.g., for another component model). Individual normalizations may distort the relationship and correlations between the data leading to issues and negative performance of a composite data model.

As referred to herein, a “modeling error” or simply an “error” may correspond to an error in the performance of the model. For example, an error in a model may comprise an inaccurate or imprecise output or prediction for the model. This inaccuracy or imprecision may manifest as a false positive or a lack of detection of a certain event. These errors may occur in models corresponding to a particular sub-segment (e.g., a component model as described herein) that result in inaccuracies for predictions and/or output based on the sub-segment, and/or the errors may occur in models corresponding to an aggregation of multiple sub-segments (e.g., a composite model as described herein) that result in inaccuracies for predictions and/or outputs based on errors received in one or more of predictions of the plurality of sub-segments and/or an interpretation of the predictions of the plurality of sub-segments.

As shown in FIG. 1, at point 104, the system may score the individual data and generate model scored data. For example, a score may indicate a degree of error (or accuracy and/or precision) for an output or prediction for the model. The model may correspond to a particular sub-segment (e.g., a component model) and/or an aggregation of multiple sub-segments (e.g., a composite model). The system may then, at point 106, generate summarized data by key input variables (e.g., which may be presented in a scorecard format (e.g., as shown in user interface 200 (FIG. 2))). For example, the input variables may correspond to a given sub-segment. For example, the system may generate a respective status summary. The respective status summary may include any qualitative or quantitative description of data (e.g., error patterns, predictions, assessments) of one or more composite data models and/or component data models.

At point 108, the system may generate one or more integrated views and testing capabilities. For example, by using non-normalized data, the system may maintain an ability to review and compare native data (e.g., native data and comparisons that may have been distorted if normalized). The system may then generate, at point 110, charts and tables for deeper insight analysis of model performance. For the purpose of evaluating model performance, a model developer or validator may create multiple charts and tables. At a high level these charts and tables provide an overall model performance through time and/or snapshots for a particular period, e.g., for each snapshot it summarizes performance over a given time period (e.g., a 12 month period, 27 month period, etc.). For example, these charts, tables, snapshot, and/or scorecard may be presented as recommendations to a user. As referred to herein, a recommendation may comprise any quantitative or qualitative assessment that is generate by the system. For example, a recommendation may comprise a respective status summary as shown in FIG. 2A.

For example, the system may leverage codes written by model developers to create summary tables of model performance by key segments (e.g., a segment or sub-segment corresponding to a component model) and for different snapshots across time. The summary tables may be exported for further analysis by creating charts from the summary tables. These charts and summary tables are evaluated to draw inferences on model performance and highlight major model weaknesses. While this process helps in identifying any major weaknesses based on business defined thresholds (e.g., user inputted thresholds, parameters, hyperparameters, etc. for one or more models), the system may perform additional analysis to detect key changes in error distribution patterns through time or sub-segment biases (e.g., bias based on detected errors in one or more models) and trends based on size/materiality (e.g., an amount that an individual component model affects an output of a composite model).

The system may also provide next-level representations that include individual snapshot performance over 12 months or 27 months. For example, evaluating the performance of these models on different snapshots of time covering both in-time as well as out of time is key to analyzing performance-based risk with the future usage of the model based on business defined materiality thresholds (e.g., an amount that an individual component model affects an output of a composite model. Additionally, the capability to dive deeper into sub-segment level evaluation is key to identifying pockets of model underperformance or risk of error cancellations.

For example, in a conventional system, an analyst may receive thousands of charts (e.g., corresponding to respective component models), which have different error patterns through time as well as different error variance where it is difficult to ascertain risk without evaluating the materiality of the segment. This conventional process aligned with business defined thresholds may help the analyst evaluate risk at a higher level but since the evaluation is strictly dependent on breaching the threshold, certain error trends through time or for material sub-segments can be missed in this process.

FIG. 2A shows an illustrative model scorecard as presented in a user interface, in accordance with one or more embodiments. For example, the model scorecard may provide the capability to have a deeper look at a sub segment or component level model performance by highlighting segments and sub-segments that fail anon-parametric bias test while also having significant materiality (e.g., an amount that an individual component model affects an output of a composite model) that might affect the overall performance of the composite model.

The system may provide analytical capability through intelligent evaluation of sub-segment model performance despite noise created by smaller segments with lower materiality show significantly higher error variance. The system combines the materiality of the sub-segment based on the proportion of events falling in the sub-segment with the level of bias that exists in the sub-segment (e.g., as determined by a non-parametric bias test based on error sign of individual observations).

The system may also provide a table (e.g., table 202) with a combined view of the sub-segments with the WMPE along with proportions of events for each sub-segment. Sub-segments with the highest score of materiality and bias may be highlighted or emphasized (e.g., by using a color highlight (not shown) or other shading or emphasis). Table 202 comprises numerous scorecards in the rows and segments in the columns. For each scorecard, the top row shows the WMPE and the bottom row in grey shows a proportion of actual errors or events in the specific sub-segment. As shown, the scorecard may include shading, highlighting, and/or other visual distinctions in order to draw a user attention. In some embodiments, the system may present actual values or textual descriptions.

As described herein, the WMPE is a measure of prediction accuracy of a forecasting method. In some embodiments, a Weighted Mean Absolute Percentage Error (WMAPE) may be used with a sign indicating the bias of the error detections. The WMAPE may be determined based on the formula below where A is a vector of the actual data and F is the forecast:

$$WMAPE = \frac{{\sum }_{t = 1}^{n} \vert {A}_{t} - {F}_{t} \vert}{{\sum }_{t = 1}^{n} \vert {A}_{t} \vert}$$

The above table highlights segment 2 since it has high errors of E2% coupled with high P2% proportion of actual errors making it material enough to impact overall performance. The scorecard level breakdowns various segments (e.g., segments 1-4) as well as sub-segments across those segments (e.g., corresponding to scorecards A through J). Scorecards A and J show material errors due to higher proportion of actual errors in these segments. Using the system, analysts can further deep-dive into horizon level view of actual and predicted errors for the highlighted sub-segment to evaluate the bias further.

FIG. 2B shows an illustrative snapshot diagram as presented in a user interface, in accordance with one or more embodiments. For example, the system may provide snapshot views of a composite data model and/or a time-series data component model. These snapshots may comprise outputs of individual models and provide data upon which individual error detection may be determined. For example, the system may generate a snapshot based on a user selection of an icon (e.g., a section of user interface 200 (FIG. 2)). For example, the system may generate a recommendation (e.g., one or more values for a respective status summary) for adjustments to a time-series data component model of the plurality of time-series data component models based on the respective WMPE and the respective proportion of error detections for each of the plurality of time-series data component models. The system may receive a user selection of the recommendation and generate a graph 250. In another example, the system may receive a user selection of an icon corresponding to a time-series data component model of the plurality of time-series data component models. In response to the user selection, the system may generate actual and predicted data for the time-series data component model.

For example, the system may analyze a graph 250 to determine points of change in error distributions over time (e.g., point 252, point 254, and point 256). That is, the scorecard level breakdown shown in FIG. 2A may be based on data shown in graph 250. For example, the system may provide intelligent recommendations (e.g., a respective status summary) based on data-driven statistical tests, while taking user input in the form of allowable business thresholds (e.g., an error threshold) and number of breaches (e.g., an allowable number of detections during a first time period). By doing so, the system isolates outliers from true change in error patterns. While outliers can be detected using manual inspection, more gradual changes in error patterns are difficult to discern manually. The system incorporates the user input by simulating pre-built error mean and variances drawn from a normal distribution with 0 mean and variance that ensures that an acceptable low percentage of error values breach the business thresholds when there is no change in the underlying error distribution. By doing so, the system detects any change from the first time period of model build data. Subsequently, changes in error patterns are highlighted based on the number of breaches from the previous error distribution. Graph 250 indicates an example, having WMPE for horizon 1-28 plotted through time, highlighting this capability.

For example, the first 15 data points may be based on a simulation from a i.i.d “normal” distribution with mean 0. As shown in the example, the pre-great recession errors (i.e., errors prior to the 2008 time period) fall under the same distribution. However, based on change-point analysis, the system detects a shift from April 2008 onwards as the mean error changes with higher under prediction observed during recession. As shown in graph 250, the error pattern reverses around 2010 during economic recovery where the model relationship changes once again, with the new error mean slightly above the pre-recession error mean. This error distribution changes once again in 2016 as errors start falling with newer vintages having a different error pattern. In the absence of change-point analysis and with evaluation based on business thresholds, a system could not determine the material risk with the model performance around 2008 and 2016. Using change-point analysis, however, the system may further refine the model specification and improve model performance.

For example, the system uses change-point analysis to discern if a significant shift in error mean has taken place over a longer period of time. That is, the system implements a change point analysis on top of error/forecast model performance. This is different from the usual usage of change-point analysis to detect deviation in the data generation process as the system is based on detections being caused by the changes in underlying model relationship. Accordingly, the system and monitoring tool are used to identify this. The system also provides additional capability to detect change-point analysis at the sub-segment level while highlighting the proportion of events falling in the sub-segment for different points in time as a measure of sub-segment materiality (e.g., as shown in FIG. 2A).

As described herein, “change-point analysis” comprises an analysis performed on time-series data in order to detect whether any changes have occurred. It determines the number of changes and estimates the time of each change. It further provides confidence levels for each change and confidence intervals for the time of each change. Change-point analysis has several benefits. No specific distribution is assumed; thus, it is appropriate for non-homogenous, time-series data segments and may be used for all types of time ordered data including, data from non-normal distributions, and data with outliers. If change-point analysis is applied on the ranks, it will provide results that are robust to outliers. Change-point analysis can also detect subtle changes which may not be detected by control charts. Change-point analysis characterizes the changes detected by providing associated confidence levels and confidence intervals (CI's) for the times of the changes as well. The system may use a recursive algorithm to detect multiple change-points by splitting a given time series into two sub-series repeatedly and by applying the change point analysis algorithm on each sub-series to find a change-point based on cumulative sums of the sub-series. A change-point indicates the series' mean shifts from its previous mean to another.

The system may use various algorithms, additionally or alternatively, for conducting the change-point analysis including binary segmentation, Pruned Exact Linear Time (PELT), window-based change detection, and dynamic programming. The system may select a method based on a computational cost associated with the algorithm used. Binary segmentation is an approximate method with an efficient computational cost of O (n log n), where n is the number of data points. The algorithm works by iteratively applying a single change-point method to the entire sequence to determine if a split exists. If a split is detected, then the sequence splits into two sub-sequences. The same process is then applied to both sub-sequences, and so on. The PELT method is an exact method, and generally produces quick and consistent results. It detects change points through the minimization of costs. The algorithm has a computational cost of O(n), where n is the number of data points. Dynamic programming search method is an exact method, which has a considerable computational cost of O(Qn\hat{ }2), where Q is the max number of change points and n is the number of data points. Window-based search method computes the discrepancy between two adjacent windows that move along with signal y. When the two windows are highly dissimilar, a high discrepancy between the two values occurs, which is indicative of a change-point. Upon generating a discrepancy curve, the algorithm locates optimal change-point indices in the sequence.

The system may highlight key model weakness by scientifically evaluating not only the points where thresholds (e.g., an error threshold) are breached but also points where significant change in error pattern has taken place by doing change-point analysis. These changes in error pattern signify changes in the underlying model relationship and, depending on the magnitude of the shift, it helps cover risk in model specification which has failed to incorporate potential error pattern changes. Additionally, given a change point or even for other time periods, the system provides the capability to have a deeper look at the sub-segment model performance by highlighting segments that fail the non-parametric bias test while also having significant materiality that might affect the overall performance (e.g., as described in FIG. 2A). Additionally or alternatively, non-parametric bias tests help evaluate trends of under-prediction or over-prediction which can be fixed by changing the model specification instead of giving importance to the magnitude of the variance which can be inherently wide due to the size of the sub-segment.

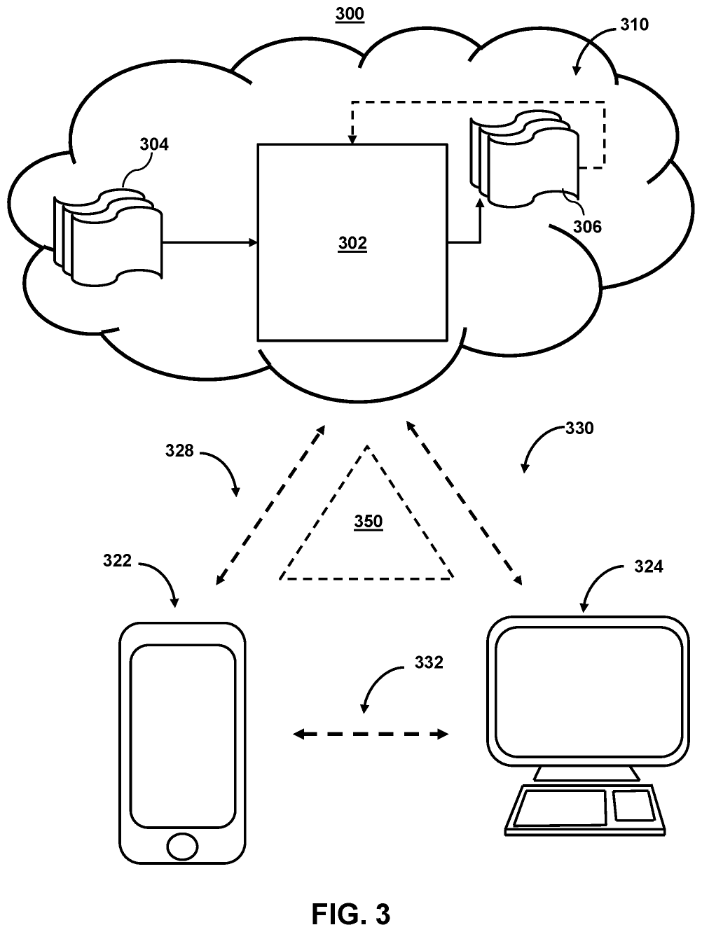

FIG. 3 shows illustrative components for detecting modeling errors at a composite modeling level in complex computer systems, in accordance with one or more embodiments. For example, system 300 may represent the components used for detecting modeling errors and generating scorecards and snapshots as shown in FIGS. 2A and B. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may be a database configured to store user data for a user. For example, the database may include user data that the system has collected about the user through prior interactions, both actively and passively. For example, the user data may describe one or more characteristics of a user, a user device, and/or one or more interactions of the user with a user device and/or application generating responses, queries, and/or notifications. Alternatively, or additionally, the system may act as a clearing house for multiple sources of information about the user. This information may be compiled into a user profile. Cloud components 310 may also include control circuitry configured to perform the various operations needed to generate alternative content. For example, the cloud components 310 may include cloud-based storage circuitry configured to generate alternative content. Cloud components 310 may also include cloud-based control circuitry configured to run processes to determine alternative content. Cloud components 310 may also include cloud-based input/output circuitry configured to display alternative content.

Cloud components 310 may include model 302, which may be a machine learning model, artificial intelligence model, etc. (which may be referred collectively as “models” herein). (Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., a user-generated data entry, word, severity level, etc.).

In some embodiments, model 302 may predict alternative content. For example, the system may determine that particular characteristics are more likely to be indicative of a prediction. In some embodiments, the model (e.g., model 302) may automatically perform actions based on outputs 306. In some embodiments, the model (e.g., model 302) may not perform any actions. The output of the model (e.g., model 302) may be used to generate for display, on a user interface, a recommendation based on the severity level.

System 300 also includes API layer 350. API layer 350 may allow the system to generate summaries across different devices. In some embodiments, API layer 350 may be implemented on user device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

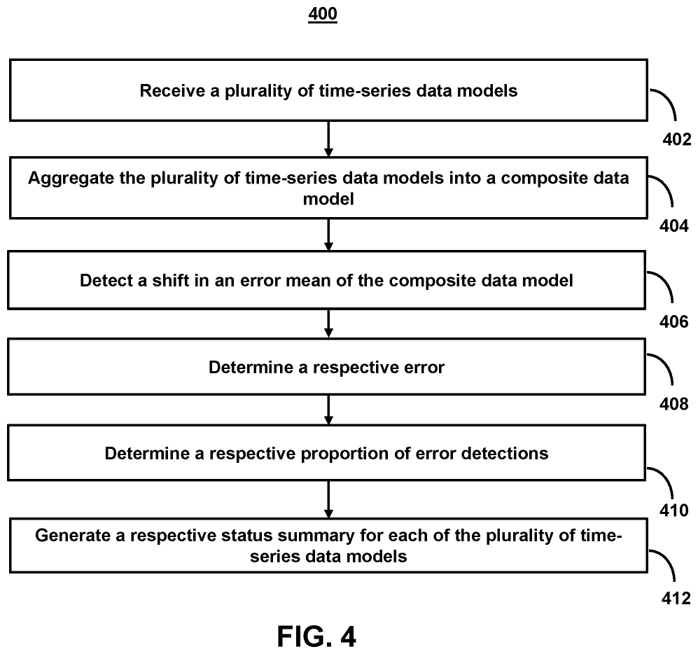

FIG. 4 shows a flowchart of the steps involved in detecting modeling errors at a composite modeling level in complex computer systems, in accordance with one or more embodiments. For example, the system may use process 400 (e.g., as implemented on one or more system components) in order to generate a snapshot or scorecard as shown in FIGS. 2A and B.

At step 402, process 400 (e.g., using one or more components described in system 300 (FIG. 3)) receives a plurality of time-series data component models. For example, the system may receive a plurality of time-series data component models for a first time period, wherein each of the plurality of time-series data component models provide a respective error pattern for a respective forecasting model of a respective data stream segment.

At step 404, process 400 (e.g., using one or more components described in system 300 (FIG. 3)) aggregates the plurality of time-series data component models into a composite data model. For example, the system may aggregate the plurality of time-series data component models into a composite data model for the first time period, wherein the composite data model provides a composite error pattern during the first time period.

At step 406, process 400 (e.g., using one or more components described in system 300 (FIG. 3)) detects a shift in an error mean of the composite data model. For example, the system may detect a shift in an error mean of the composite data model based on a change point analysis on error distributions in the composite error pattern. The error mean comprises an average of all errors detected during the first time period.

In some embodiments, the system may receive a first user input of an error threshold. The system may also receive a second user input of an allowable number of detections during a first time period. The system may then generate a pre-built error mean and variance with a normal distribution based on the first user input and the second user input. By doing so, the system may detect any change right from the first time period of model build data. Subsequently, the system may detect changes in error patterns based on the number of breaches (e.g., error detections) from the previous error distribution. For example, the system may generate intelligent recommendations (e.g., a respective status summary) based on data driven statistical tests, while taking user input in the form of allowable business thresholds and number of breaches. By doing so, the system may isolate outliers from true change in error patterns. While outliers can be detected using manual inspection, more gradual changes in error patterns are difficult to discern manually. The system may incorporate the user input by simulating pre-built error mean and variances drawn from a normal distribution with zero mean and variance that ensures that an acceptable low percentage of error values breach the business thresholds (e.g., errors are detected) when there is no change in the underlying error distribution.

At step 408, process 400 (e.g., using one or more components described in system 300 (FIG. 3)) determines a respective error (if any). For example, the system may determine a respective error (or error location) for one or more of the plurality of time-series data component models based on a non-parametric bias test in response to detecting the shift in the error mean of the composite data model. The detection error may be based on determining a non-parametric bias and/or one or more WMPE's for one or more of the plurality of time-series data component models. By detecting the error (or the component model generating the error), the system is able to determine a location (e.g., a component model) from which an error is occurring. Additionally, the bias may be based on an error sign of the error detections by the time-series data component model. For example, by using the WMPE as opposed to a weighted absolute mean percentage error, the system may determine an error sign for the WMPE. In some embodiments, the system may alternatively or additionally generate an additional WMPE (e.g., for the composite data model or a subset of the plurality of time-series data component models).

In some embodiments, the respective WMPE for each of the plurality of time-series data component models based on the non-parametric bias test indicates a prediction accuracy of a respective time-series data component model of the plurality of time-series data component models. For example, a key distinction between the parametric and non-parametric test is that the parametric test relies on statistical distributions in data whereas non-parametric do not depend on any distribution. Accordingly, the use of the non-parametric test in the present application may reduce the need for normalization of data as non-parametric does not make any assumptions and measures the central tendency with the median value.

At step 410, process 400 (e.g., using one or more components described in system 300 (FIG. 3)) determines a respective proportion of error detections. For example, the system may determine a respective proportion of error detections for each of the plurality of time-series data component models that occurred during the first time period in response to detecting the shift in the error mean of the composite data model.

At step 412, process 400 (e.g., using one or more components described in system 300 (FIG. 3)) generates a respective status summary for each of the plurality of time-series data component models. For example, the system may generate for display, on a user interface, a respective status summary for each of the plurality of time-series data component models, wherein the respective status summary includes the respective WMPE and the respective proportion of error detections for each of the plurality of time-series data component models.

In some embodiments, the system may provide additional recommendations based on the status summary. For example, the system may generate a recommendation (e.g., highlighting a model for a sub-segment with modeling errors) for adjustments to a time-series data component model of the plurality of time-series data component models based on the respective WMPE and the respective proportion of error detections for each of the plurality of time-series data component models. For example, the system may determine a time-series data component model of the plurality of time-series data component models with a highest score of materiality and bias. The system may generate a recommendation for adjustment to the time-series data component model. For example, the system may determine the materiality based on a proportion of error detections by the time-series data component model.

It is contemplated that the steps or descriptions in FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the devices or equipment discussed in relation to FIGS. 1-3 could be used to perform one or more of the steps in FIG. 4.

The above-described embodiments of the present disclosure are presented for purposes of illustration, and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for detecting modeling errors at a composite modeling level in complex computer systems based on modeling errors in non-homogenous, time-series data segments, the method comprising: receiving a plurality of time-series data component models for a first time period, wherein each of the plurality of time-series data component models provide a respective error pattern for a respective forecasting model of a respective data stream segment; aggregating the plurality of time-series data component models into a composite data model for the first time period, wherein the composite data model provides a composite error pattern during the first time period; detecting a shift in an error mean of the composite data model based on a change point analysis on error distributions in the composite error pattern; in response to detecting the shift in the error mean of the composite data model: determining a respective error (e.g., a WMPE) for each of the plurality of time-series data component models based on a non-parametric bias test; and determining a respective proportion of error detections for each of the plurality of time-series data component models that occurred during the first time period; and generating for display, on a user interface, a respective status summary for each of the plurality of time-series data component models, wherein the respective status summary includes the respective WMPE and the respective proportion of error detections for each of the plurality of time-series data component models.
2. The method of any one of the preceding embodiments, further comprising: receiving a first user input of an error threshold; receiving a second user input of an allowable number of detections during a first time period; and generating a pre-built error mean and variance with a normal distribution based on the first user input and the second user input.
3. The method of any one of the preceding embodiments, wherein the pre-built error mean is set to zero.
4. The method of any one of the preceding embodiments, further comprising generating a recommendation for adjustments a time-series data component model of the plurality of time-series data component models based on the respective WMPE and the respective proportion of error detections for each of the plurality of time-series data component models.
5. The method of any one of the preceding embodiments, further comprising: determining a time-series data component model of the plurality of time-series data component models with a highest score of materiality and bias: and generating a recommendation for adjustment to the time-series data component model.
6. The method of any one of the preceding embodiments, further comprising determining the materiality based on a proportion of error detections by the time-series data component model.
7. The method of any one of the preceding embodiments, wherein the bias is based on an error sign of the error detections by the time-series data component model.
8. The method of any one of the preceding embodiments, further comprising: receiving a user selection of an icon corresponding to a time-series data component model of the plurality of time-series data component models; and in response to the user selection, generating actual and predicted data for the time-series data component model.
9. The method of any one of the preceding embodiments, wherein the respective error (e.g., a WMPE) for each of the plurality of time-series data component models based on a non-parametric bias test indicates a prediction accuracy of a respective time-series data component model of the plurality of time-series data component models.
10. The method of any one of the preceding embodiments, wherein the error mean comprises an average of all errors detected during the first time period.
11. A tangible, non-transitory, machine-readable medium storing instructions that, when executed by a data processing apparatus, cause the data processing apparatus to perform operations comprising those of any of embodiments 1-10.
12. A system comprising: one or more processors; and memory storing instructions that, when executed by the processors, cause the processors to effectuate operations comprising those of any of embodiments 1-10.
13. A system comprising means for performing any of embodiments 1-10.

What is claimed is:

1. A system for detecting modeling errors at a composite modeling level in complex computer systems based on modeling errors in non-homogenous, time-series data segments, the system comprising:
storage circuitry configured to store a plurality of time-series data component models for a first time period, wherein each of the plurality of time-series data component models provide a respective error pattern for a respective forecasting model of a respective data stream segment;
control circuitry configured to:
aggregate the plurality of time-series data component models into a composite data model for the first time period, wherein the composite data model provides a composite error pattern during the first time period;
detect a shift in an error mean of the composite data model based on a change point analysis on error distributions in the composite error pattern, wherein the error mean comprises an average of all errors detected during the first time period;
in response to detecting the shift in the error mean of the composite data model:
determine a respective error for each of the plurality of time-series data component models based on a non-parametric bias test; and
determine a respective proportion of error detections for each of the plurality of time-series data component models that occurred during the first time period; and
input/output circuitry configured to:
generate for display, on a user interface, a snapshot of the composite data model for the first time period;
generate for display, on the user interface, a respective status summary for each of the plurality of time-series data component models, wherein the respective status summary includes the respective error and the respective proportion of error detections for each of the plurality of time-series data component models, and wherein the respective status summary for each of the plurality of time-series data component models is selectable by a user; and
generate for display, on a user interface, a snapshot of a data model of the plurality of time-series data component models in response to a user selection of the respective status summary for the data model.

2. A method for detecting modeling errors at a composite modeling level in complex computer systems based on modeling errors in non-homogenous, time-series data segments, the method comprising:
receiving a plurality of time-series data component models for a first time period, wherein each of the plurality of time-series data component models provide a respective error pattern for a respective forecasting model of a respective data stream segment;
aggregating the plurality of time-series data component models into a composite data model for the first time period, wherein the composite data model provides a composite error pattern during the first time period;
detecting a shift in an error mean of the composite data model based on a change point analysis on error distributions in the composite error pattern;
in response to detecting the shift in the error mean of the composite data model:
determining a respective error for each of the plurality of time-series data component models based on a non-parametric bias test; and
determining a respective proportion of error detections for each of the plurality of time-series data component models that occurred during the first time period; and
generating for display, on a user interface, a respective status summary for each of the plurality of time-series data component models, wherein the respective status summary includes the respective error and the respective proportion of error detections for each of the plurality of time-series data component models.

3. The method of claim 2, further comprising:
receiving a first user input of an error threshold;
receiving a second user input of an allowable number of detections during a first time period; and
generating a pre-built error mean and variance with a normal distribution based on the first user input and the second user input.

4. The method of claim 3, wherein the pre-built error mean is set to zero.

5. The method of claim 2, further comprising generating a recommendation for adjustments to a time-series data component model of the plurality of time-series data component models based on the respective error and the respective proportion of error detections for each of the plurality of time-series data component models.

6. The method of claim 2, further comprising:
determining a time-series data component model of the plurality of time-series data component models with a highest score of materiality and bias: and
generating a recommendation for adjustment to the time-series data component model.

7. The method of claim 6, further comprising determining the materiality based on a proportion of error detections by the time-series data component model.

8. The method of claim 6, wherein the bias is based on an error sign of the error detections by the time-series data component model.

9. The method of claim 2, further comprising:
receiving a user selection of an icon corresponding to a time-series data component model of the plurality of time-series data component models; and
in response to the user selection, generating actual and predicted data for the time-series data component model.

10. The method of claim 2, wherein the respective error for each of the plurality of time-series data component models based on the non-parametric bias test indicates a prediction accuracy of a respective time-series data component model of the plurality of time-series data component models.

11. The method of claim 2, wherein the error mean comprises an average of all errors detected during the first time period.

12. A non-transitory, computer readable medium for detecting modeling errors at a composite modeling level in complex computer systems based on modeling errors in non-homogenous, time-series data segments comprising instructions that when executed by one or more processors cause operations comprising:
receiving a plurality of time-series data component models for a first time period, wherein each of the plurality of time-series data component models provide a respective error pattern for a respective forecasting model of a respective data stream segment;
aggregating the plurality of time-series data component models into a composite data model for the first time period, wherein the composite data model provides a composite error pattern during the first time period;
detecting a shift in an error mean of the composite data model based on a change point analysis on error distributions in the composite error pattern;
in response to detecting the shift in the error mean of the composite data model:
determining a respective error for each of the plurality of time-series data component models based on a non-parametric bias test; and
determining a respective proportion of error detections for each of the plurality of time-series data component models that occurred during the first time period; and
generating for display, on a user interface, a respective status summary for each of the plurality of time-series data component models, wherein the respective status summary includes the respective error and the respective proportion of error detections for each of the plurality of time-series data component models.

13. The non-transitory, computer readable medium of claim 12, wherein the instructions further cause operations comprising:
receiving a first user input of an error threshold;
receiving a second user input of an allowable number of detections during a first time period; and
generating a pre-built error mean and variance with a normal distribution based on the first user input and the second user input.

14. The non-transitory, computer readable medium of claim 13, wherein the pre-built error mean is set to zero.

15. The non-transitory, computer readable medium of claim 12, wherein the instructions further cause operations comprising generating a recommendation for adjustments to a time-series data component model of the plurality of time-series data component models based on the respective error and the respective proportion of error detections for each of the plurality of time-series data component models.

16. The non-transitory, computer readable medium of claim 12, wherein the instructions further cause operations comprising:
determining a time-series data component model of the plurality of time-series data component models with a highest score of materiality and bias: and
generating a recommendation for adjustment to the time-series data component model.

17. The non-transitory, computer readable medium of claim 16, wherein the instructions further cause operations comprising determining the materiality based on a proportion of error detections by the time-series data component model.

18. The non-transitory, computer readable medium of claim 16, wherein the bias is based on an error sign of the error detections by the time-series data component model.

19. The non-transitory, computer readable medium of claim 12, wherein the instructions further cause operations comprising:
receiving a user selection of an icon corresponding to a time-series data component model of the plurality of time-series data component models; and
in response to the user selection, generating actual and predicted data for the time-series data component model.

20. The non-transitory, computer readable medium of claim 12, wherein the respective error for each of the plurality of time-series data component models based on the non-parametric bias test indicates a prediction accuracy of a respective time-series data component model of the plurality of time-series data component models.
